(19) United States
(12) Patent Application Publication
(10) Pub. No.: US 2012/0055100 A1
(43) Pub. Date: Mar. 8, 2012

(54) METHOD AND APPARATUS FOR PRODUCING METAL BOND GRIND STONE

(76) Inventors: Hiroshi Yamazoe, Kyoto (JP); Masahiro Itoi, Kyoto (JP); Tomohiko Mitani, Kyoto (JP); Taro Sonobe, Osaka (JP)

(21) Appl. No.: 13/263,156

(22) PCT Filed: May 26, 2010
(86) PCT No.: PCT/JP2010/058922

§ 371 Date: Oct. 6, 2011

(30) Foreign Application Priority Data
May 29, 2009 (JP) 2009-130949

(51) Int. Cl. C09K 3/14; B22F 3/10

(52) U.S. Cl. 51/309; 425/78

(57) ABSTRACT

A metal bond grind stone producing method in which electric power consumption is reduced is provided. In the metal bond grind stone producing method, a sintered metal bond grind stone is obtained by a sintering process of sintering a metal bond grind stone material that is a mixture of a metal binder powder and abrasive grains. In the sintering process, the metal bond grind stone material containing the metal binder powder is heated with microwaves to obtain the sintered metal bond grind stone. The sintering process may be a pressure sintering process of performing microwave heating while pressurizing the metal bond grind stone material.

### TECHNICAL FIELD

The present invention relates to a method and an apparatus for producing a metal bond grind stone.

### BACKGROUND ART

Metal bond grind stones are obtained by sintering a grind stone material (mixed powder) in which abrasive grains are dispersed in a metal bond powder such as copper, tin, and silver (see Patent Literature 1). For sintering such metal bond grind stones, a hot press method and a discharge plasma method are conventionally used.

### CITATION LIST

### [Patent Literature]

[Patent Literature 1] Japanese Laid-Open Patent Publication No. 2008-44070

### SUMMARY OF INVENTION

### Technical Problem

In the hot press method and the discharge plasma method, however, electric power consumption for heating needs to be, for example, about 16 kW and thus is high.

Here, as a heating method in which electric power consumption is low, the inventors of the present invention focused on heating with microwaves. However, metal has a property of reflecting microwaves, and thus it is common technological knowledge that metal cannot be heated with microwaves.

Thus, it is conventionally thought that microwave heating is unsuitable for sintering metal bond grind stones, and no example exists where microwave heating is used for sintering metal bond grind stones.

Meanwhile, the inventors of the present invention conducted an experiment on the basis of an idea of using heating with microwaves for sintering metal bond grind stones which idea defies conventional common sense. As a result, the inventors succeeded in sintering a metal bond grind stone by means of microwave heating, and completed the present invention.

In other words, an object of the present invention is to provide a novel method and a novel apparatus, for producing a metal bond grind stone, in which electric power consumption is reduced.

### Solution to Problem

As a result of an experiment, the inventors of the present invention found that when a metal bond grind stone material containing a metal binder powder is heated with microwaves, sintering can be performed since the binder is metal but is in powder form.

In other words, the present invention is a metal bond grind stone producing method for obtaining a sintered metal bond grind stone by a sintering process of sintering a metal bond grind stone material that is a mixture of a metal binder powder and abrasive grains. In the sintering process, the metal bond grind stone material containing the metal binder powder is heated with microwaves to obtain the sintered metal bond grind stone.

Further, preferably, the sintering process is a pressure sintering process of performing microwave heating while pressurizing the metal bond grind stone material, and in the pressure sintering process, heating with microwaves is started under a pressure lower than a final pressurizing pressure in the pressure sintering process, and a pressurizing pressure is increased during increasing of a temperature by the microwave heating, whereby the pressurizing pressure reaches the final pressurizing pressure.

Preferably, the increase of the pressurizing pressure to the final pressurizing pressure is performed when a temperature of the metal bond grind stone material reaches an intermediate temperature, and the intermediate temperature is equal to or near a melting point of a metal binder powder composed of a metal having a melting point lower than a target temperature for the microwave heating among a plurality of types of metal binder powders contained in the metal bond grind stone material.

Preferably, the sintering process is a pressure sintering process of performing microwave heating while pressurizing the metal bond grind stone material, and a pressurizing pressure in the pressure sintering process is an initial pressurizing pressure lower than a final pressurizing pressure, at start of the microwave heating, is increased to an intermediate pressurizing pressure that is between the initial pressurizing pressure and the final pressurizing pressure, before reaching a target temperature for the microwave heating, and then is increased further to the final pressurizing pressure.

Preferably, the increase of the pressurizing pressure to the intermediate pressurizing pressure is performed when a temperature of the metal bond grind stone material reaches an intermediate temperature, and the intermediate temperature is equal to or near a melting point of a metal binder powder composed of a metal having a melting point lower than a target temperature for the microwave heating among a plurality of types of metal binder powders contained in the metal bond grind stone material.

According to another aspect, the present invention is a metal bond grind stone producing apparatus comprising: a mold for receiving therein a metal bond grind stone material that is a mixture of a metal binder powder and abrasive grains, and a microwave generation section for heating the metal bond grind stone material received in the mold, with microwaves emitted from the outside of the mold.

Preferably, the mold is formed from a dielectric material having microwave permeability.

Preferably, the metal bond grind stone producing apparatus further comprises a temperature measurement section, provided to the mold, for measuring a temperature of the metal bond grind stone material within the mold, and the mold contains a material having microwave permeability and having such thermal conductivity that the temperature of the metal bond grind stone material can be reflected to a position at which the temperature measurement section is provided.

Preferably, the metal bond grind stone producing apparatus further comprises a temperature measurement section for measuring a temperature of the metal bond grind stone material within the mold, the mold comprises a first mold portion formed from a dielectric material having microwave permeability, and a second mold portion, formed from a material having higher thermal conductivity than the first mold portion, for transmitting heat of the metal bond grind stone material to the temperature measurement section, and the temperature measurement section measures the temperature of the metal bond grind stone material via the second mold portion.

### Advantageous Effects of Invention

According to the present invention, a metal bond grind stone can be sintered by means of microwave heating that allows electric power saving, and the production cost of the grind stone can be reduced.

### BRIEF DESCRIPTION OF DRAWINGS

FIG. 1 is a configuration diagram of a grind stone producing apparatus using microwave heating.

FIG. 2 is a perspective view of a mold for receiving a grind stone material which mold is used in the grind stone producing apparatus.

FIG. 3 is an enlarged view illustrating a processing section of the grind stone producing apparatus.

FIG. 4 is a cross-sectional view taken along the A-A line in FIG. 3.

FIG. 5 is a graph illustrating a first example of a microwave heating control method.

FIG. 6 is a graph illustrating a second example of the microwave heating control method.

FIG. 7 is a graph illustrating a third example of the microwave heating control method.

FIG. 8 is a graph illustrating a fourth example of the microwave heating control method.

FIG. 9 is a graph illustrating a microwave heating control method (temperature-pressure control) according to Example 2.

FIG. 10 is a graph illustrating a microwave heating control method (temperature-pressure control) according to Example 3.

### DESCRIPTION OF EMBODIMENTS

Hereinafter, a preferred embodiment of the present invention will be described with reference to the accompanying drawings.

### 1. Grind Stone Producing Apparatus

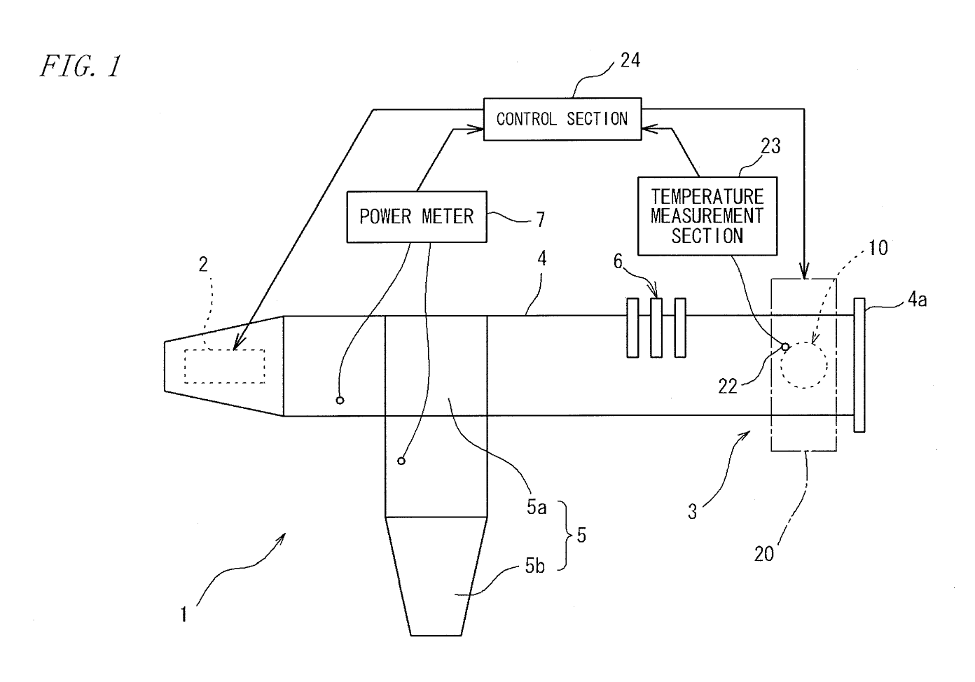

FIG. 1 illustrates a grind stone producing apparatus 1 according to an embodiment. The producing apparatus 1 is configured as a microwave heating apparatus with a pressurization function. The microwave heating apparatus is a single-mode apparatus that performs heating with standing waves (combinations of incident waves and reflected waves). Therefore, when a grind stone material (a mold 10) is installed at a position where an electric field or a magnetic field is maximum, heating can efficiently be performed. It should be noted that as a microwave heating apparatus, a multimode apparatus can be used.

The producing apparatus 1 includes a microwave generation section (oscillation section) 2, a processing section 3 for heating, with microwaves, a grind stone material that is a to-be-heated object, and a waveguide 4 for transmitting microwaves toward the processing section 3 side. It should be noted that the waveguide 4 includes a short-circuit plate 4a at its end.

The microwave generation section 2 is composed of, for example, a magnetron, and can generate, for example, microwaves of 2.45 GHz. However, the frequency is not limited thereto, and may be, for example, 915 MHz or 5.8 GHz. Alternatively, a semiconductor amplifier may be used as the microwave generation section 2.

Here, the electric power consumption of the microwave generation section 2 suffices to be, for example, about 400 W, and thus the electric power consumption can be reduced significantly as compared to electric power consumption of 16 kW in the conventional grind stone producing method (e.g., a hot press method).

In the producing apparatus 1, in a middle portion of the waveguide 4 to the processing section 3, an isolator 5 and a stab tuner 6 are provided.

The isolator 5 is composed of a circulator 5a and a dummy load 5b. In the circulator 5a, the microwaves generated by the microwave generation section 2 pass toward the processing section 3 side, but microwaves reflected from the processing section 3 side do not return to the microwave generation section 2 and are sent toward the dummy load 5b side. In addition, the apparatus 1 includes a power meter 7 for measuring the electric power of the microwaves (incident waves) outputted from the microwave generation section 2 and the electric power of the microwaves (reflected waves) reflected from the processing section 3 side, to calculate electric power absorbed at the processing section 3.

It should be noted that the stab tuner (impedance matching device) 6 can adjust the resonant length of microwaves.

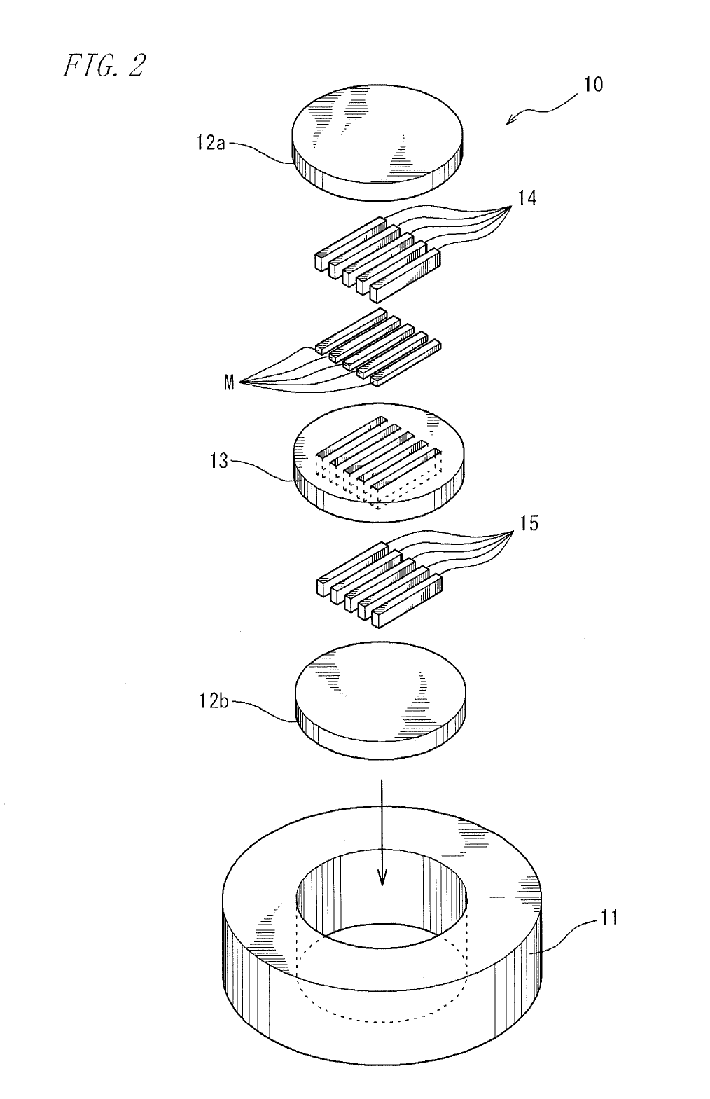

FIGS. 2 to 4 illustrate the configuration of the apparatus 1 regarding the processing section 3. The processing section 3 is provided within the waveguide 4 and is used for obtaining a grind stone (e.g., a honing grind stone) obtained by pressure-sintering a grind stone material. In the processing section 3, sintering is performed by microwave heating with microwaves that are emitted from the microwave generation section 2 and pass through the waveguide 4. Specifically, the mold 10 for receiving an unsintered grind stone material is located at a predetermined position within the waveguide 4 where an electric field or a magnetic field is maximum, and microwaves that have passed through the mold 10 heat the grind stone material within the mold 10.

As shown in FIG. 2, the mold 10 includes a cylindrical mold body (first mold portion) 11, an inner mold 13 (first mold portion) for receiving a grind stone material, upper and lower press molds 14 and 15 (second mold portion) for entering the inner mold 13 from above and below to pressurize a grind stone material M from above and below, and pressing plates (second mold portion) 12a and 12b for pressing the upper and lower press molds 14 and 15.

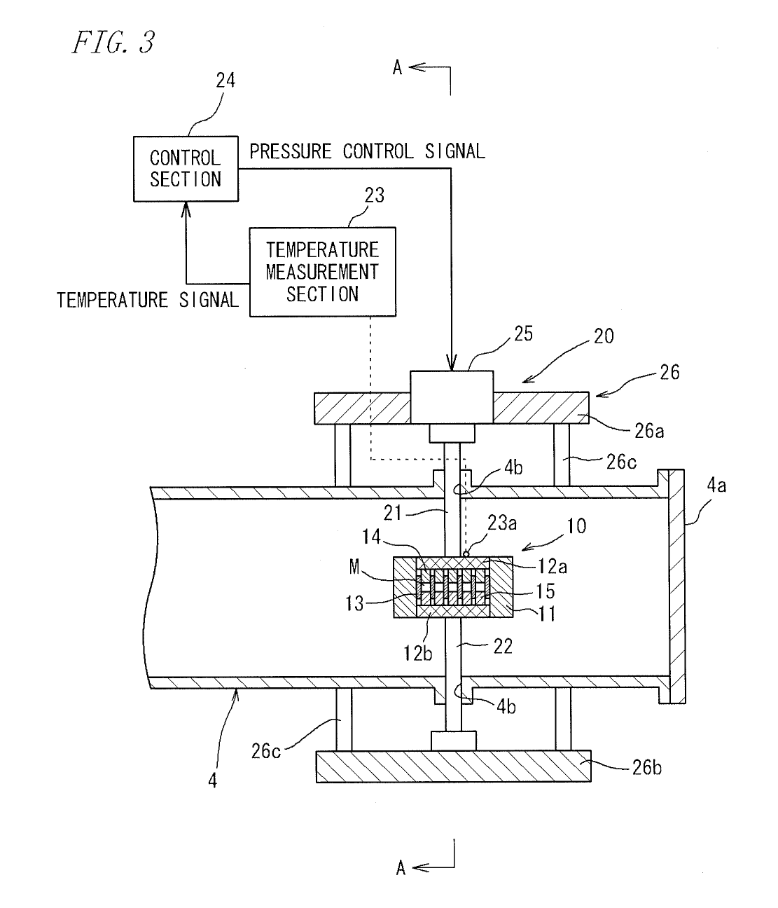

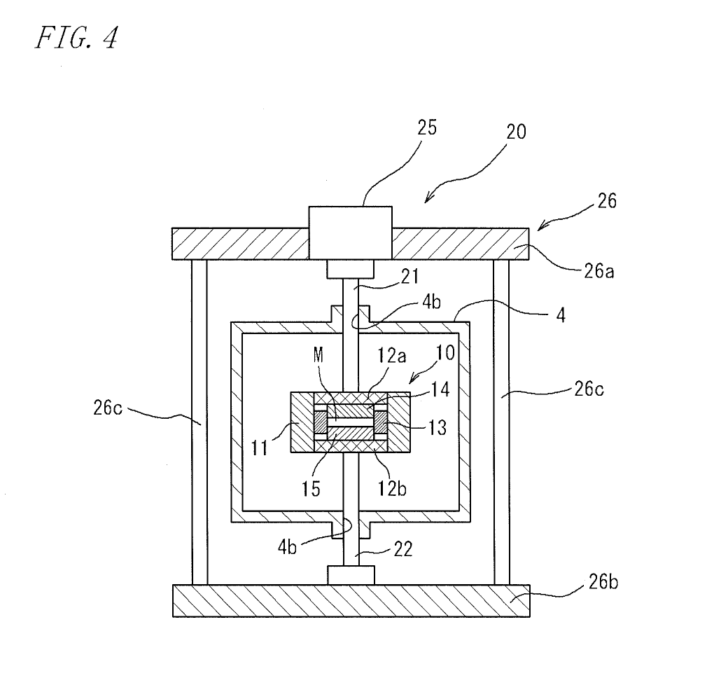

As shown in FIGS. 3 and 4, the upper and lower press molds 14 and 15 are pressurized by pressure rods 21 and 22 of a pressure device 20 via the pressing plates 12a and 12b to pressurize the grind stone material M.

The mold 10 is formed from a dielectric material that absorbs less microwaves and generates less heat from microwaves, such as ceramics. Since the mold 10 absorbs less microwaves, even if microwaves are applied thereto from the outside of the mold 10, the microwaves are mainly absorbed by the grind stone material M, and the amount of microwaves absorbed by the mold 10 is small. Thus, the power efficiency is good.

The mold 10 may be entirely formed from a single type of material (e.g., alumina) in view of the above respect. However, in the present embodiment, in order to facilitate monitoring of the temperature of a grind stone material, the mold 10 is formed from a plurality of types (two types) of materials.

Specifically, the cylindrical mold body (first mold portion) 11 and the inner mold (first mold portion) 13 are formed from alumina (aluminum oxide; Al₂O₃), and the upper and lower press molds (second mold portion) 14 and 15 and the pressing plates (second mold portion) 12a and 12b are formed from an aluminum nitride-boron nitride composite (AlN—BN).

Here, the above-mentioned alumina is a kind of ceramics and has microwave permeability, and thus is unlikely to be heated with microwaves and is suitable for suppressing microwave absorption of the mold 10.

However, in general, the thermal conductivity of ceramics such as alumina is not necessarily high. If the thermal conductivity of the mold 10 is low, when measuring the temperature of the grind stone material M via the mold 10 during the sintering process, the temperature difference between the mold 10 and the grind stone material M becomes great and it is difficult to measure an accurate temperature of the grind stone material M.

Meanwhile, aluminum nitride and boron nitride are ceramics and have microwave permeability similarly to alumina, but are materials having high thermal conductivity as ceramics (dielectrics).

Therefore, in the present embodiment, as the material of the mold 10, alumina is used, and an aluminum nitride-boron nitride composite that is a material having higher thermal conductivity than alumina is used for a portion where it is desired to ensure excellent thermal conduction for temperature measurement.

In other words, in the present embodiment, as described above, the mold body 11 and the inner mold 13, which are the first mold portion, are formed from alumina, and the upper and lower press molds 14 and 15 and the pressing plates 12a and 12b, which are the second mold portion, are formed from the aluminum nitride-boron nitride composite. It should be noted that the second mold portion may be fotined from aluminum nitride or boron nitride.

The press molds 14 and 15 come into contact with the grind stone material M, and a thermocouple that is a temperature detection section 23a is provided on the outer surface of the pressing plate 12a that comes into contact with the press molds 14. It should be noted that the temperature detection section 23a may be buried in the second mold portion in a state of being out of contact with the grind stone material M.

Therefore, the press molds and the pressing plate (the upper press molds 14 and the pressing plate 12a in FIG. 3) form a main path for thermal conduction from the grind stone material M to the temperature detection section 23a. In the present embodiment, since a material having high thermal conductivity is used as the material for forming the thermal conduction path, the temperature of the grind stone material M during heating is reflected to the temperature detection section 23a and more accurate measurement of the temperature of the grind stone material M becomes possible.

It should be noted that the entire shape of the mold 10, the shape of the first mold portion, and the shape of the second mold portion are not limited to the illustrated shapes, and various modifications are possible. In addition, the material of the first mold portion and the material of the second mold portion are not limited to the above-mentioned materials. Further, the mold 10 does not need to be formed from a plurality of materials and may be formed from a single material.

As the material for forming the mold 10, for example, in view of microwave permeability (low dielectric loss), silicon nitride, silicon oxide, or the like can also be used in addition to alumina, aluminum nitride-boron nitride composite, aluminum nitride, or boron nitride, which are exemplified above. Further, composite materials of these materials or composite materials of these materials and other materials may be used. It should be noted that the mold 10 may partially contain a material having high dielectric loss (e.g., SiC or carbon).

As described above, since the mold 10 is mainly formed from material having lower dielectric loss in the frequency of the microwaves used for heating than the grind stone material that is the to-be-heated object, microwave heating can be performed while power loss is reduced.

Further, as described above, since the material having high thermal conductivity such as an aluminum nitride-boron nitride composite or aluminum nitride is used among the above-mentioned materials, measurement of the temperature of the grind stone material is facilitated. In addition, with a material having low thermal conductivity, the temperature difference between a portion of the mold 10 close to the grind stone material and a portion of the mold 10 distant from the grind stone material becomes great, and strain is likely to occur in the mold 10. Therefore, in view of preventing a decrease of the durability that is caused by strain, materials having high thermal conductivity are preferred.

It should be noted that as other conditions for selecting materials for the mold 10, since pressurization is performed, materials having excellent hardness or shock resistance are preferred.

The temperature detection section (thermocouple) 23a is connected to a temperature measurement section 23, and the temperature measurement section 23 provides a measured temperature signal to a control section 24. The control section 24 serves to control a firing process of the apparatus 1, and, for example, can control the pressurizing pressure of the pressure device 20 on the basis of the measured temperature.

The pressure device 20 serves to apply a load to the press molds 14 and 15 from above and below with a pair of the upper and lower pressure rods 21 and 22 via the pressing plates 12a and 12b to pressurize the grind stone material M. The pressure device 20 is a hydraulic type and includes a hydraulic cylinder as a pressure generation section 25 for generating a desired pressurizing pressure corresponding to a pressure control signal provided from the control section 24.

The pressure generation section 25 is provided outside the waveguide 4 but the pressure rods 21 and 22 extend into the waveguide 4, whereby the pressure generation section 25 can apply a load to the mold 10 within the waveguide 4. When the pressure generation section 25 is provided within the waveguide 4, constraints arise, for example, it is necessary to reduce the size of the pressure generation section 25 to a size that allows the pressure generation section 25 to be accommodated in the waveguide 4, or a metal component that reflects microwaves cannot not be used as a component of the pressure generation section 25. When the pressure generation section 25 is provided outside the waveguide 4, the pressure generation section 25 is released from such constraints.

The pressure generation section 25 is supported by a support 26 outside the waveguide 4. The support 26 includes an upper support portion 26a, a lower support portion 26b, and a connection portion 26c that connects the upper and lower support portions 26a and 26b.

The pressure generation section 25 is supported by the upper support portion 26b, and the upper pressure rod (moveable rod) 21 is mounted to the pressure generation section 25. In addition, the lower pressure rod (fixed rod) 22 is fixed to the lower support portion 26b. It should be noted that the lower pressure rod 22 may also be a moveable rod.

Both of the pressure rods 21 and 22 are partially located within the waveguide 4, and thus are formed from a dielectric material having low microwave reflectivity or absorptivity, such as ceramics. Specifically, the pressure rods 21 and 22 in the present embodiment are formed from alumina. It should be noted that the entireties of the pressure rods 21 and 22 are formed from alumina in the present embodiment, but it suffices that portions thereof that can be located within the waveguide 4 are formed from alumina (a dielectric material such as ceramics).

Further, through holes 4b in order for the pressure rods 21 and 22 to extend therethrough are formed in the waveguide 4. The through holes 4b need to be reduced to such sizes that microwaves within the waveguide 4 do not leak through the through holes 4b, and thus cannot be very large. Therefore, the pressure rods 21 and 22 that are inserted through the through holes 4b cannot also be very thick.

The illustrated pressure rods 21 and 22 are provided only as one upper pressure rod and one lower pressure rod, but a plurality of upper pressure rods and a plurality of lower pressure rods may be provided. In other words, a plurality of upper through holes 4b and a plurality of lower through holes 4b may be provided in the waveguide 4, and the mold 10 may be pressed with a plurality of pressure rods 21 and a plurality of pressure rods 22. By so doing, while the size of each of the through holes 4b is reduced to prevent microwaves from leaking, the load applied to the respective pressure rods 21 and 22 can be dispersed.

It should be noted that the pressurization direction is not limited to the vertical direction, and may be, for example, a horizontal direction.

### 2. Grind Stone Material and Heating Thereof

The grind stone material to be processed by the apparatus 1 is a material of a metal bond grind stone, and specifically, a mixture of a metal binder powder and abrasive grains. According to need, a filler is added to the grind stone material.

The metal binder powder (bond material) is preferably powders of one or more metal binders selected from the group consisting of copper, tin, silver, nickel, zinc, cobalt, iron, and aluminum. These metal binder powders form a binder phase of a grind stone by being sintered. The average particle size of the metal binder powder is about 2 μm to 65 μm.

It should be noted that the melting point of each material that is to be the metal binder powder is as follows. Specifically, the melting point of copper is 1084° C., the melting point of tin is 232° C., the melting point of silver is 962° C., the melting point of nickel is 1455° C., the melting point of zinc is 420° C., the melting point of cobalt is 1495° C., the melting point of iron is 1535° C., and the melting point of aluminum is 660° C.

The abrasive grains are grains of one or more members selected from the group consisting of diamond (C), CBN (cubic boron nitride; BN), GC (green silicon carbide; SiC), C (black silicon carbide; SiC), WA (white alumina; Al₂O₃), and A (gray alumina; Al₂O₃). When diamond or CBN is used as abrasive grains, its concentration is preferably about 20 to 150.

The filler is one or more members selected from the group consisting of GC (green silicon carbide; SiC), C (black silicon carbide; SiC), WA (white alumina; Al₂O₃), A (gray alumina; Al₂O₃), zirconia (ZrO₂), molybdenum disulfide (MoS₂), boron nitride (BN), carbon (C), and hollow ceramic balloon.

It should be noted that the melting point of each material that is to be the filler is as follows. Specifically, the melting points of GC and C are 2730° C., the melting points of WA and A are 2054° C., the melting point of zirconia is 2715° C., the melting point of molybdenum disulfide is 1085° C., and the melting point of hollow ceramic balloon is 1600° C.

The metal bond grind stone material contains metal (the metal binder powder) as described above. In general, metal (conductor) reflects radio waves, and thus is not heated with microwaves. However, through an experiment, the invertors of the present invention were able to confirm that the above-mentioned metal bond grind stone material can be heated by application of microwaves.

Here, the reason why the metal bond grind stone material containing the metal binder powder can be heated is inferred to be that electromagnetic waves scattered by the metal binder powder propagate in the metal binder powder, whereby an eddy current occurs in the metal binder powder, and the metal bond grind stone material is heated with the Joule's heat generated due to eddy current loss.

The microwave power absorbed by the metal bond grind stone material depends on the particle size of the metal binder powder. When the average particle size of the metal binder powder was about 2 μm to 65 μm as described above, heating with microwaves of 2.45 GHz was possible. If the particle size of the metal binder powder is excessively large or small, heating with microwaves cannot be performed. Thus, the average particle size of the metal binder powder is preferably as described above. It should be noted that the average particle size of the metal binder powder is more preferably about 5 μm to 10 μm.

When microwave heating is performed on the metal bond grind stone material, the metal bond grind stone material generates heat by itself, and heating can be performed inside the grind stone material.

On the other hand, in the conventional method for producing a metal bond grind stone (e.g., a hot press method), heating is performed from the outside of the grind stone material. Thus, the outer portion of the grind stone material is cured initially, and gas generated inside the grind stone material during heating cannot escape to the outside, whereby a state where the inside is flexible is likely to occur. If such a state is provided, during use as a grind stone, the grinding force becomes non-uniform, the service life of the grind stone is shortened, the amount of heat generated during grinding increases, and the quality of the grind stone deteriorates.

In microwave heating, unevenness of heating is small, and the entire grind stone material can be cured substantially uniformly. Thus, the above problems are less likely to occur, and it is easy to obtain a good quality grind stone as compared to the conventional production method.

In addition, in microwave heating, the temperature can be increased in a short time as compared to the conventional production method. Thus, the heating time can be shortened, and degradation (oxidation) of the abrasive grains can be suppressed.

### 3. Method for Controlling Apparatus in Sintering Process (Control of Heating and Pressurization)

Hereinafter, variations of a method for controlling a sintering process by the control section 24 will be described.

### 3.1 Only Microwave Heating

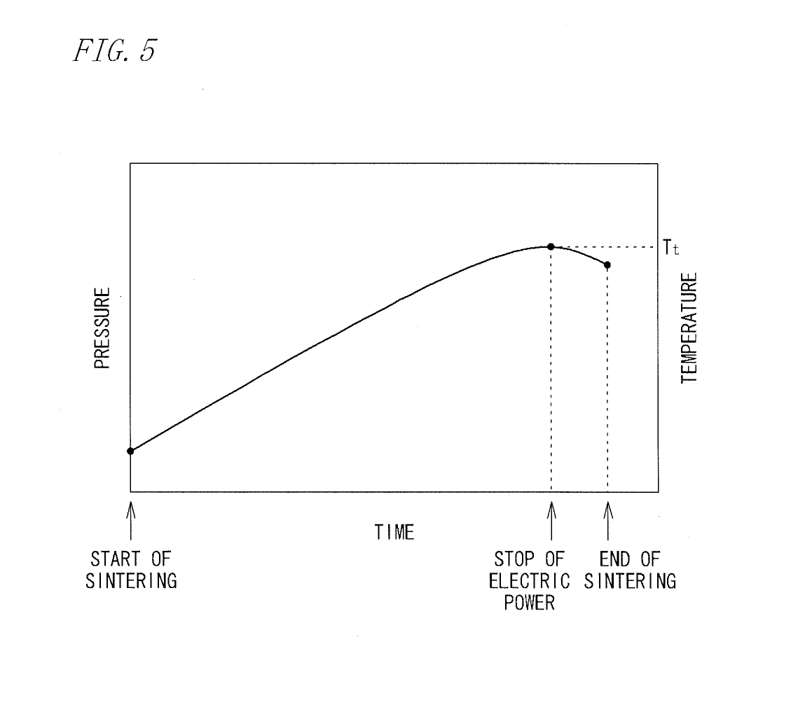

FIG. 5 illustrates an example of a temperature change when microwave heating is performed on the grind stone material without pressurization. At start of the sintering process, the control section 24 causes the microwave generation section 2 to generate microwaves. The output of the microwave generation section 2 is, for example, 400 W, and the period from start of sintering to end of sintering is about 20 to 30 minutes.

When the temperature of the grind stone material measured by the temperature measurement section 23 becomes a target temperature (sintering temperature) Tt for microwave heating, the control section 24 stops the microwave generation section 2 from generating microwaves, and after a short time, the sintering process ends and sintered grind stones are taken out.

### 3.2 Microwave Heating under Constant Pressurizing Pressure

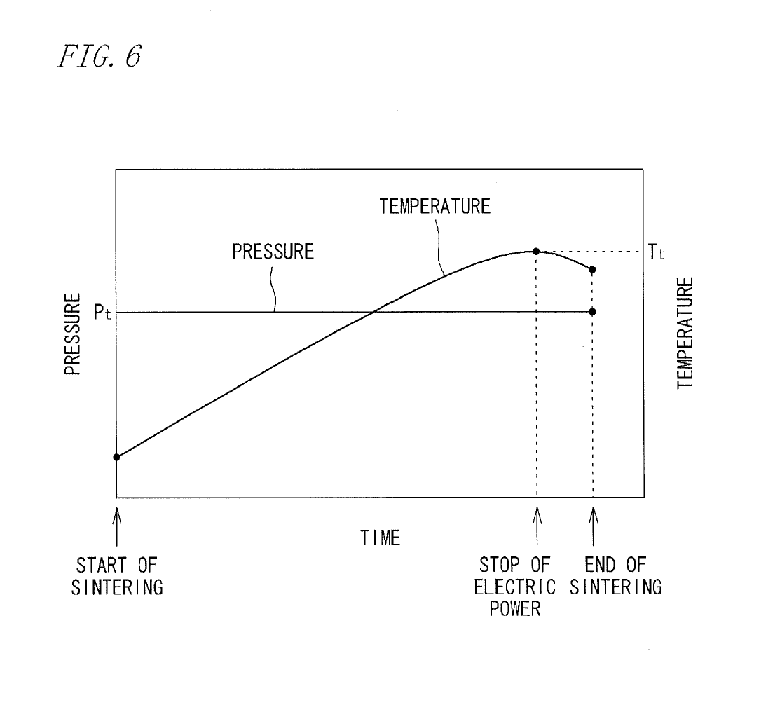

FIG. 6 illustrates an example of temperature and pressure when microwave heating is performed on the grind stone material while pressurization is performed at a constant pressure from start to end of the sintering process. Prior to start of the sintering process, the control section 24 causes the pressure device 20 to press the mold 10 that is set within the waveguide 4, to pressurize the grind stone material. The pressurizing pressure is a predetermined sintering pressure Pt. The sintering pressure Pt is set as appropriate on the basis of the components of the grind stone material and desired grind stone performance, and, for example, Pt=35 Mpa.

The control section 24 causes the microwave generation section 2 to generate microwaves with the sintering pressure Pt maintained, to perform a pressure sintering process. In this case as well, the output of the microwave generation section 2 is, for example, 400 W, and the period from start of sintering to end of sintering is about 20 to 30 minutes.

When the temperature of the grind stone material measured by the temperature measurement section 23 becomes a target temperature (sintering temperature) Tt for microwave heating, the control section 24 stops the microwave generation section 2 from generating microwaves, and after a short time, the pressure sintering process ends and sintered grind stones are taken out.

In the case of the metal bond grind stone material, the metal binder powder is composed of a plurality of types of metal powders, and the average particle size may be different between the metal types. In this case, ease of being heated with microwaves is different between the types of metal powders, and a local increase in temperature may occur in the metal bond grind stone material unless pressurization is performed as shown in FIG. 5.

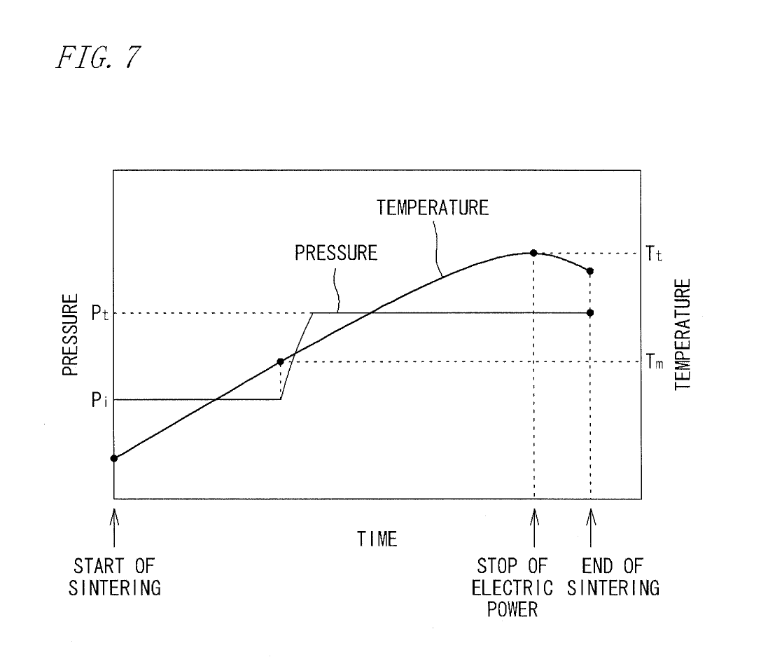

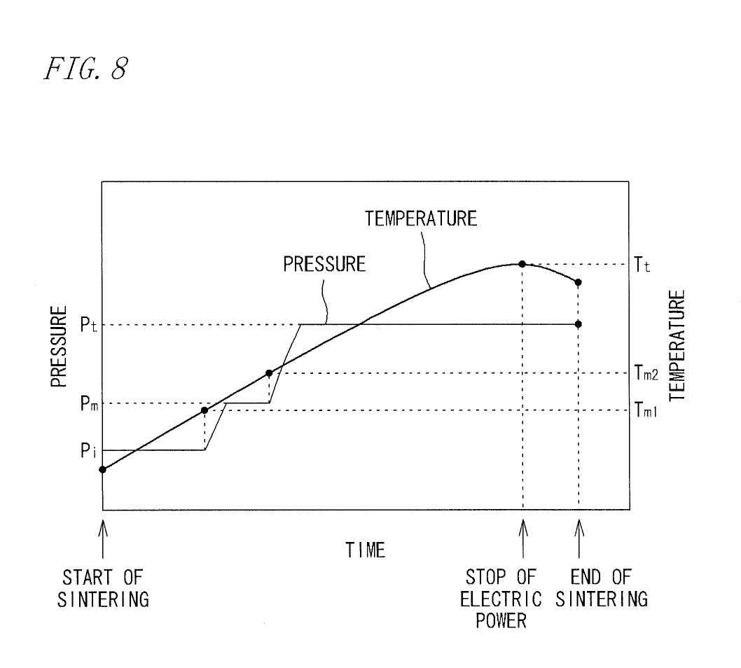

In such a case as well, if pressurization is performed as shown in FIG. 6 (or FIGS. 7 and 8), the temperature of the entire metal bond grind stone material is likely to uniformly increase.

Further, in general, sintering is performed at a temperature equal to or lower than the melting point of a to-be-sintered obj ect. In the case of sintering a grind stone, the sintering temperature Tt is generally about 500° C. However, in the case of the metal bond grind stone material, the metal binder powder in which a plurality of types of metal powders are mixed contains a material having a melting point lower than the sintering temperature Tt (e.g., tin whose melting point is 232° C.).

Thus, during sintering, the low melting point material (such as tin) having a melting point lower than the sintering temperature Tt may melt. In addition, in microwave heating, the grind stone material is heated from its inside. Thus, the low melting point material that melts inside the grind stone material seeps out onto the surface of the grind stone material, and a state where a glossy metal surface is formed on the surface of the grind stone material is likely to occur. When such a state is provided, the low melting point material that seeps out onto the surface of the grind stone material reflects microwaves, thereby making microwave heating difficult.

However, when microwave heating is performed while pressurization is performed as shown in FIG. 6 (or FIGS. 7 and 8), a state where the plurality of types of metal powders are mixed can be maintained by the pressurization, and even if the low melting point material such as tin is contained, the low melting point material can be prevented from seeping out.

### 3.3 Microwave Heating with Two-Stage Pressurization

FIG. 7 illustrates an example of temperature and pressure when microwave heating is performed on the grind stone material while a pressurizing pressure is changed in two stages from start to end of the sintering process. Prior to start of the sintering process, the control section 24 causes the pressure device 20 to press the mold 10 that is set within the waveguide 4, to pressurize the grind stone material at an initial pressurizing pressure (first pressure) Pi.

The control section 24 causes the microwave generation section 2 to generate microwaves in the state of the above initial pressurizing pressure Pi, to start a pressure sintering process. When the temperature of the grind stone material measured by the temperature measurement section 23 becomes an intermediate temperature Tm (Tm<Tt), the control section 24 increases the pressure generated by the pressure generation section 25, to a final pressurizing pressure (sintering pressure; second pressure) Pt. The increase from the initial pressurizing pressure Pi to the final pressurizing pressure Pt may be performed instantly, but is preferably performed gradually (e.g., for about one minute) as shown in FIG. 7.

Then, the control section 24 continues the microwave heating with the final pressurizing pressure Pt maintained, When the temperature of the grind stone material measured by the temperature measurement section 23 becomes a target temperature (sintering temperature) Tt for microwave heating, the control section 24 stops the microwave generation section 2 from generating microwaves, and after a short time, the pressure sintering process ends and sintered grind stones are taken out.

It should be noted that in this case as well, the electric power of the microwave generation section 2 is, for example, 400 W, and the period from start of sintering to end of sintering is about 20 to 30 minutes.

When pressurization is performed in two stages as shown in FIG. 7, the load applied to the mold 10 and the pressure rods 21 and 22 can be reduced as a whole of the sintering process. In the case of microwave heating, as described above, the mold 10 and the pressure rods 21 and 22, which are located within the waveguide 4, are preferably formed from ceramic material that is less influenced by microwaves. However, the ceramic material has inferior shock resistance as compared to metallic material, and thus it is preferred that the load is reduced by the two-stage pressurization as shown in FIG. 7.

Further, in microwave heating, the grind stone material is rapidly heated from its inside. Thus, when generation of gas also from the central portion of the grind stone material during heating is taken into consideration, in order to accelerate escape of the gas to the outside of the grind stone material, it is desired that a great pressure (Pt) is not applied at the initial stage of the sintering process as shown in FIG. 6, but the pressurizing pressure (Pi) at the initial stage of the sintering process is set to be relatively small and then the pressurizing pressure is increased to the final pressurizing pressure (sintering pressure) Pt.

The initial pressurizing pressure Pi suffices to be a relatively low pressure that is required to ensure heating uniformity of the metal binder powder composed of a plurality of types of metal materials, and is preferably, for example, about equal to or lower than ½ of the final pressurizing pressure Pt. For example, when the final pressurizing pressure Pt is 36 MPa, the initial pressurizing pressure Pi can be set to about 18 MPa.

The intermediate temperature Tm, which is used for determining timing of increase from the initial pressurizing pressure Pi to the final pressurizing pressure Pt, is preferably set to a temperature that is equal to or near the melting point of the above low melting point material (more preferably, a temperature that is near the melting point of the low melting point material and is higher than the melting point).

For example, when the low melting point material contained in the metal binder powder is tin (melting point: 232° C.), the intermediate temperature Tm can be set to, for example, about 250 to 300° C. In this case, the grind stone material is pressurized at the relatively low pressure Pi at the initial stage of the sintering process, and the pressurizing pressure can be changed to the higher pressure Pt at timing when tin starts to melt.

### 3.4 Microwave Heating with Three-Stage Pressurization

FIG. 8 illustrates an example of temperature and pressure when microwave heating is performed on the grind stone material while a pressurizing pressure is changed in three stages from start to end of the sintering process. Prior to start of the sintering process, the control section 24 causes the pressure device 20 to press the mold 10 that is set within the waveguide 4, to pressurize the grind stone material at an initial pressurizing pressure (first pressure) Pi.

The control section 24 causes the microwave generation section 2 to generate microwaves in the state of the above initial pressurizing pressure Pi, to start a pressure sintering process. When the temperature of the grind stone material measured by the temperature measurement section 23 becomes a first intermediate temperature Tm1 (Tm1<Tt), the control section 24 increases the pressure generated by the pressure generation section 25, to an intermediate pressurizing pressure Pm (Pi<Pm<Pm). Further, when the temperature of the grind stone material measured by the temperature measurement section 23 becomes a second intermediate temperature Tm2 (Tm1<Tm2<Tt), the control section 24 further increases the pressure generated by the pressure generation section 25, to a final pressurizing pressure Pm.

Each of the increase from the initial pressurizing pressure Pi to the intermediate pressurizing pressure Pm and the increase from the intermediate pressurizing pressure Pm to the final pressurizing pressure Pm may be performed instantly, but is preferably performed gradually (e.g., for about one minute) as shown in FIG. 8.

Then, the control section 24 continues the microwave heating with the final pressurizing pressure Pt maintained. When the temperature of the grind stone material measured by the temperature measurement section 23 becomes a target temperature (sintering temperature) Tt for microwave heating, the control section 24 stops the microwave generation section 2 from generating microwaves, and after a short time, the pressure sintering process ends and sintered grind stones are taken out.

It should be noted that in this case as well, the electric power of the microwave generation section 2 is, for example, 400 W, and the period from start of sintering to end of sintering is about 20 to 30 minutes.

When pressurization is performed in three stages as shown in FIG. 8, the load applied to the mold 10 and the pressure rods 21 and 22 can be reduced further as a whole of the sintering process, as compared to the case of the two stages.

Further, in microwave heating, the grind stone material is rapidly heated from its inside. Thus, when generation of gas also from the central portion of the grind stone material during heating is taken into consideration, in order to accelerate escape of the gas to the outside of the grind stone material, it is desired that a great pressure (Pt) is not applied at the initial stage of the sintering process as shown in FIG. 6, but the pressurizing pressure (Pi) at the initial stage of the sintering process is set to be relatively small and then the pressurizing pressure is increased to the final pressurizing pressure (sintering pressure) Pt.

The initial pressurizing pressure Pi suffices to be a relatively low pressure that is required to ensure heating uniformity of the metal binder powder composed of a plurality of types of metal materials, and is preferably, for example, about equal to or lower than ¼ of the final pressurizing pressure Pt. For example, when the final pressurizing pressure Pt is 36 MPa, the initial pressurizing pressure Pi can be set to about 9 MPa.

The intermediate temperature Tm1, which is used for determining timing of increase from the initial pressurizing pressure Pi to the intermediate pressurizing pressure Pm, is preferably set to a temperature that is equal to or near the melting point of the above low melting point material (more preferably, a temperature that is near the melting point of the low melting point material and is higher than the melting point).

Further, the second intermediate temperature Tm2, which is used for determining timing of increase from the intermediate pressurizing pressure Pm to the final pressurizing pressure Pt, is preferably set to a temperature that is slightly lower than the sintering temperature (target temperature for sintering) Tt (by about 50° C.).

For example, when sintering temperature Tt=500° C. and the low melting point material contained in the metal binder powder is tin (melting point: 232° C.), the first intermediate temperature Tm1 can be set to, for example, about 250 to 300° C. When the grind stone material reaches about 250 to 300° C., tin melts, the grind stone material contracts, and the pressure rod 21 moves downward. Thus, the grind stone material is pressurized (gradually) to the intermediate pressurization temperature Pm.

Further, the second intermediate temperature Tm2 can be set to, for example, about 450° C. By so doing, pressure sintering can be performed under the final pressurizing pressure (sintering pressure) Pt and at the target temperature (sintering temperature).

### 4. Exampl

Hereinafter, results of actually sintering a metal bond grind stone with microwave heating are shown. Here, as a metal bond grind stone material, a material, which is obtained by mixing CBN abrasive grains whose grain size is #325 (JIS B4130), at a concentration of 75 with a metal binder powder (metal bond) obtained by mixing copper (average particle size: 44 μm), tin (average particle size: 44 μm), silver (average particle size: 44 μm), and cobalt (average particle size: 2 μm) in the proportions of 50 vol %, 20 vol %, 10 vol %, and 20 vol %, respectively, was used.

In each example described below, the sintering temperature Tt of the metal bond grind stone material was set to 500° C.

Further, the size of one grind stone was set to 2.5 mm wide, 2.5 mm high, and 25 mm long, and the weight of the grind stone material for one grind stone was set to 1.215 g.

### 4.1 Example 1

In Example 1, a sintering process was performed only with microwave heating on the above metal bond grind stone material (see FIG. 5). The electric power of the microwave generation section 2 was set to 400W, and the period from start of sintering to end of sintering was set to 30 minutes.

In this case, sintering with microwave heating was able to be performed. However, since the grind stone material contains tin that is a low melting point material, it was observed that tin deposited on the surfaces of the grind stones after the sintering, and the grind stones contracted.

### 4.2 Example 2

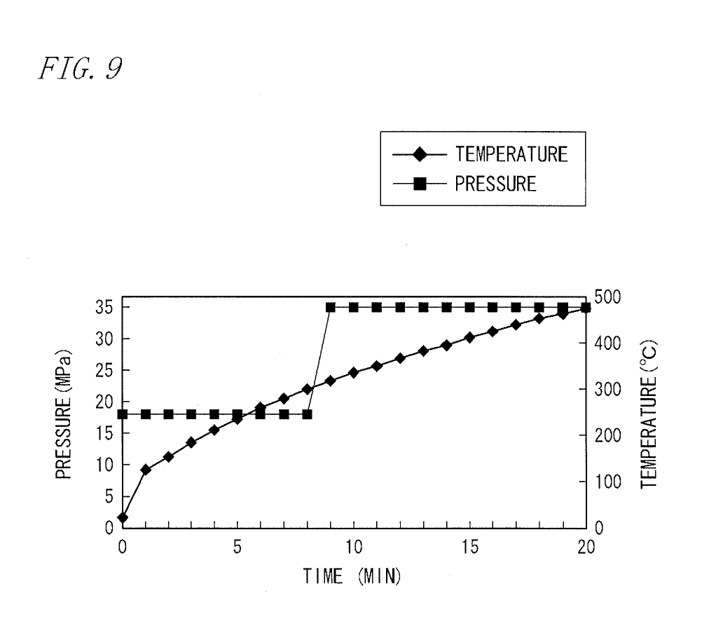

In Example 2, two-stage pressurization was performed on the above metal bond grind stone material. Changes in temperature and pressure in Example 2 are illustrated in FIG. 9. Here, initial pressurizing pressure Pi=18 MPa, and final pressurizing pressure (sintering pressure) Pt=36 MPa. In addition, intermediate temperature Tm=300° C., and the time for increasing the pressure from the initial pressurizing pressure Pi to the final pressurizing pressure Pt when the grind stone material reaches the intermediate temperature was set to one minute. Further, the time from start to completion of sintering was set to 20 minutes.

[4.3 Example 3]

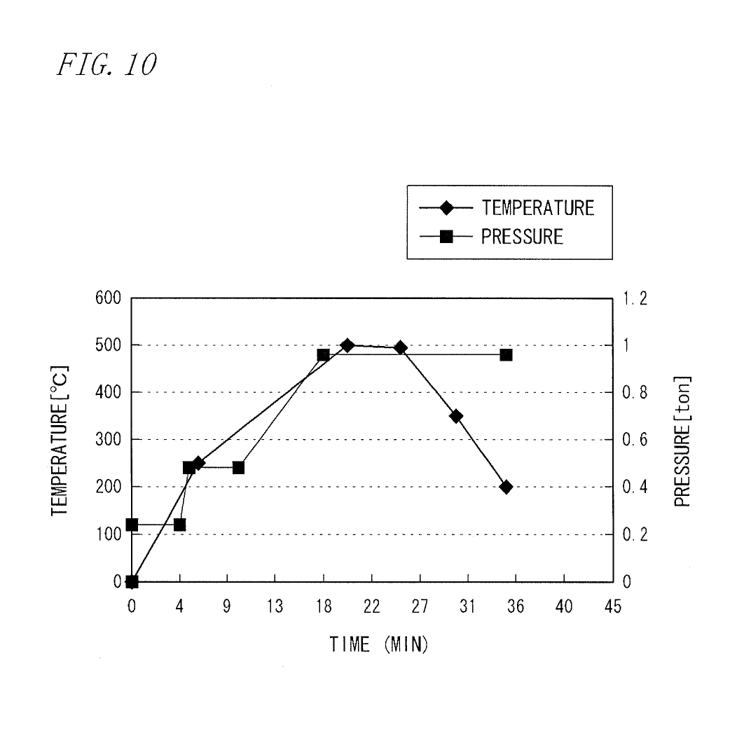

In Example 3, three-stage pressurization was performed on the above metal bond grind stone material. Changes in temperature and pressure in Example 3 are illustrated in FIG. 10. Here, initial pressurizing pressure Pi=7.5 MPa, intermediate pressurizing pressure Pm=15 MPa, and final pressurizing pressure (sintering pressure) Pt=30 MPa. Further, first intermediate temperature Tm1=180° C., and second intermediate temperature Tm2=320° C. The time from start to completion of sintering was set to 35 minutes.

It should be noted that in FIG. 10, the pressurizing pressure is indicated as a total load [ton] applied to five pieces of the grind stone material. Specifically, pressurization area per piece of grind stone material=0.625 cm², and the total pressurization area is 0.625 cm²×5 pieces=3.125 cm². Thus, the total load corresponding to the final pressurizing pressure Pt=30 MPa is 0.956 [ton].

In each of Examples 2 and 3, the obtained metal bond grind stones have good appearance, and have good density and hardness comparable to ones produced by other production methods. In addition, the service life of the grind stones obtained in Examples 2 and 3 are lengthened as compared to ones produced by other production methods. This is thought to be because even when grinding progresses, the amount of abrasion is small since the uniformity of the hardness inside the grind stone is good.

It should be noted that the present invention is not limited to the embodiment described above, and various modifications are possible. In addition, the apparatus 1 according to the present embodiment can be used for not only producing a metal bond grind stone but also sintering a resin bond grind stone or a vitrified bond grind stone. When the apparatus 1 is used for sintering a grind stone other than a metal bond grind stone, it suffices that control conditions are set according to the difference of the grind stone material.

### Reference Signs List

1 grind stone producing apparatus

2 microwave generation section

3 processing section

10 mold

11, 13 first mold portion

12a, 12b, 14, 15 second mold portion

20 pressure device

23a temperature detection section

23 temperature measurement section.

24 control section

1. A metal bond grind stone producing method for obtaining a sintered metal bond grind stone by a sintering process of sintering a metal bond grind stone material that is a mixture of a metal binder powder and abrasive grains, wherein
in the sintering process, the metal bond grind stone material containing the metal binder powder is heated with microwaves to obtain the sintered metal bond grind stone.

2. The metal bond grind stone producing method according to claim 1, wherein
the sintering process is a pressure sintering process of performing microwave heating while pressurizing the metal bond grind stone material, and
in the pressure sintering process, heating with microwaves is started under a pressure lower than a final pressurizing pressure in the pressure sintering process, and a pressurizing pressure is increased during increasing of a temperature by the microwave heating, whereby the pressurizing pressure reaches the final pressurizing pressure.

3. The metal bond grind stone producing method according to claim 2, wherein
the increase of the pressurizing pressure to the final pressurizing pressure is performed when a temperature of the metal bond grind stone material reaches an intermediate temperature, and
the intermediate temperature is equal to or near a melting point of a metal binder powder composed of a metal having a melting point lower than a target temperature for the microwave heating among a plurality of types of metal binder powders contained in the metal bond grind stone material.

4. The metal bond grind stone producing method according to claim 1, wherein
the sintering process is a pressure sintering process of performing microwave heating while pressurizing the metal bond grind stone material, and
a pressurizing pressure in the pressure sintering process is an initial pressurizing pressure lower than a final pressurizing pressure, at start of the microwave heating, is increased to an intermediate pressurizing pressure that is between the initial pressurizing pressure and the final pressurizing pressure, before reaching a target temperature for the microwave heating, and then is increased further to the final pressurizing pressure.

5. The metal bond grind stone producing method according to claim 4, wherein
the increase of the pressurizing pressure to the intermediate pressurizing pressure is performed when a temperature of the metal bond grind stone material reaches an intermediate temperature, and
the intermediate temperature is equal to or near a melting point of a metal binder powder composed of a metal having a melting point lower than a target temperature for the microwave heating among a plurality of types of metal binder powders contained in the metal bond grind stone material.

6. A metal bond grind stone producing apparatus comprising:
a mold for receiving therein a metal bond grind stone material that is a mixture of a metal binder powder and abrasive grains, and
a microwave generation section for heating the metal bond grind stone material received in the mold, with microwaves emitted from the outside of the mold.

7. The metal bond grind stone producing apparatus according to claim 6, wherein the mold is formed from a dielectric material having microwave permeability.

8. The metal bond grind stone producing apparatus according to claim 6, further comprising a temperature measurement section, provided to the mold, for measuring a temperature of the metal bond grind stone material within the mold, wherein
the mold contains a material having microwave permeability and having such thermal conductivity that the temperature of the metal bond grind stone material can be reflected to a position at which the temperature measurement section is provided.

9. The metal bond grind stone producing apparatus according to claim 6, further comprising a temperature measurement section for measuring a temperature of the metal bond grind stone material within the mold, wherein
the mold comprises a first mold portion formed from a dielectric material having microwave permeability, and a second mold portion, formed from a material having higher thermal conductivity than the first mold portion, for transmitting heat of the metal bond grind stone material to the temperature measurement section, and
the temperature measurement section measures the temperature of the metal bond grind stone material via the second mold portion.

10. The metal bond grind stone producing apparatus according to claim 7, further comprising a temperature measurement section, provided to the mold, for measuring a temperature of the metal bond grind stone material within the mold, wherein
the mold contains a material having microwave permeability and having such thermal conductivity that the temperature of the metal bond grind stone material can be reflected to a position at which the temperature measurement section is provided.

11. The metal bond grind stone producing apparatus according to claim 7, further comprising a temperature measurement section for measuring a temperature of the metal bond grind stone material within the mold, wherein
the mold comprises a first mold portion formed from a dielectric material having microwave permeability, and a second mold portion, formed from a material having higher thermal conductivity than the first mold portion, for transmitting heat of the metal bond grind stone material to the temperature measurement section, and
the temperature measurement section measures the temperature of the metal bond grind stone material via the second mold portion.
